(19) United States
(12) Patent Application Publication
(10) Pub. No.: US 2006/0078640 A1
(43) Pub. Date: Apr. 13, 2006

(54) Belt type continuous plate manufacturing apparatus and method of manufacturing sheet polymer

(76) Inventors: Hajime Okutsu, Hiroshima (JP); Hirotoshi Mizota, Tokyo (JP); Tomonari Murakami, Hiroshima (JP); Hitoshi Tomobe, Hiroshima (JP); Daisuke Morimoto, Toyama (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/537,919

(22) PCT Filed: Dec. 8, 2003
(86) PCT No.: PCT/JP03/15651

§ 371 Date: Jun. 8, 2005

(30) Foreign Application Priority Data
Dec. 10, 2002 (JP) 2002-357915
Mar. 5, 2003 (JP) 2003-58555

(51) Int. Cl. B30B 5/06

(52) U.S. Cl. 425/371

(57) ABSTRACT

Disclosed are a belt type continuous plate manufacturing apparatus including two endless belts 11, 11′ with their facing belt surfaces running toward the same direction at the same speed, and a gasket 7 sandwiched by belt surfaces at their both side edge portions, in which a polymerizable raw material is fed into a space surrounded by the facing belt surfaces and the gasket from its one end, and solidified together with running of the belts in a heating zone, and a plate polymer is taken out from the other end, wherein a plurality of upper and lower roll pairs 4, 4′ each composed of an upper roll 4 and a lower roll 4′ and having axes orthogonally grossing the belt running direction are placed along the belt running direction as a mechanism of holding the belt surfaces of the endless belts 1, 1′ in the heating zone, and the outer diameter D of the roll body portion of the upper and lower roll pair is in the range of 100 mm to 500 mm; and a method of producing a plate polymer using this apparatus.

### TECHNICAL FIELD

The present invention relates to a belt type continuous plate manufacturing apparatus of producing a plate product (i.e. plate polymer) by continuously polymerizing a polymerizable raw material, and a method of producing a plate polymer using this apparatus.

### BACKGROUND ART

Plate polymers obtained from methyl methacrylate as the main raw material are used in signboard and building material applications, sanitary application such as baths and the like, illumination application, and other wider fields, utilizing their excellent properties. Recently, they are used as a light transmission plate of displays such as liquid crystal displays, and its demand is increasing steeply, also because of world wide spreading of the IT technology.

Of course, such a light transmission plate is required to have high optical properties as a material, however, there is also required extremely high dimension precision along the thickness direction (hereinafter, abbreviated as “plate thickness precision” in some cases) in comparison with conventional applications so that brilliance distribution in display is not formed.

On the other hand, there is a continuous casting method using a belt type continuous plate manufacturing apparatus, as a method of continuously producing a plate polymer. This belt type continuous plate manufacturing apparatus is an apparatus in which a polymerizable raw material is fed between facing belt surfaces of two endless belts placed at upper and lower positions and running at the same speed along the horizontal direction, from one end side of the belts, the polymerizable raw material is polymerized by a method such as heating together with movement of the endless belts, and the plate polymer is removed from another end side. In this apparatus, a plurality of upper and lower roll pairs having axes orthogonally crossing the belt running direction are placed along the belt running direction as a belt surface holding mechanism. The width direction plate thickness precision of the plate polymer is determined by conditions of rigidity of roll body portions of upper and lower roll pairs, an arrangement distance of upper and lower roll pairs in the belt running direction, an inner liquid pressure of a raw material between the rolls caused by a linear load applied to the belt surface from the upper roll, tension of the endless belt, and the like.

As a method of improving the width direction plate thickness precision in the belt type continuous plate manufacturing apparatus, there is a method in which attention is given to an effect of lifting the belt between upper and lower roll pairs by an inner liquid pressure of a raw material, the body portion of the roll is designed to have high rigidity, the axis portion is designed to have low rigidity, the axis portion is preferentially deformed to follow volumetric shrinkage of the liquid raw material, and a linear load on the belt surface is thereby maintained to improve the plate thickness precision, as shown in, for example, Japanese Patent Publication No. 51-27467.

However, if the rigidity of the roll body portion is ensured to improve the plate thickness precision as in this method, the plate thickness precision is not necessarily improved in a belt type plate manufacturing apparatus having a wide endless belt.

The reason is as follows. Namely, as can be understood from the formula (2) described later, the amount of deflection of the roll body portion when a width direction uniform load is applied to the roll body portion by an inner liquid pressure of a raw material is generally proportional to the fourth power of the width of the roll body portion. Therefore, if the width of the endless belt is increased, the plate product has a centrally thickened shape due to transfer of a deflected shape of the roll body portion. It is necessary to increase the roll body diameter for further improving the rigidity of the roll body portion, but if the roll body is designed to have a large diameter, the roll arrangement distance in the belt running direction must be necessarily kept wide, and this promotes deflection of the endless belt between roll pairs, resulting in a degradation in plate thickness precision of the product. Further, if the distance between upper and lower roll pairs is kept too large, the risk of leakage of a raw material liquid to outside a gasket increases especially in a district near a raw material feeding portion where the content of polymer is low, and it is undesirable in terms of safety and operational management.

As described above, it is difficult in conventional technologies to produce a plate product of high plate thickness precision using a belt type continuous plate manufacturing apparatus of high productivity.

Furthermore, in this apparatus, the surface appearance of a product depends on the surface state of an endless belt substantially in contact with the product, and therefore the smoothness of the surface of the endless belt is very important. For example, if the surface of an endless belt is so insufficiently polished that fine irregularities are left on the surface, fine irregularities are transferred onto the surface of a plate product, and they may be seen as if they were small scars in visual observation. Furthermore, if large irregularities locally exist on the surface of an endless belt, bright spots may appear on the plate surface. It has been already difficult to use such a plate product in recent optical applications requiring an extremely strict smoothness.

As an endless belt suitable for the belt type continuous plate manufacturing apparatus, there is a stainless steel plate subjected to an anode electrolytic process via a medium containing water in an amount of 20% or greater under an electrolytic strength of 1.0 V/cm or greater as shown in, for example, Japanese Patent Publication No. 02-33490.

However, the electrolysis process shown in Japanese Patent Publication No. 02-33490 is intended for improvement of solvent resistance of a plate product, and effects on the smoothness of the surface of an endless belt are not mentioned. Namely, this publication is not aimed at smoothness of the plate product and inhibition of bright spots, which are concerned in optical applications, and no consideration is given to what configuration is effective in this respect.

### DISCLOSURE OF THE INVENTION

The present invention has been made to solve the above-mentioned problems in conventional technologies. Namely, an object of the present invention is to provide a belt type continuous plate manufacturing apparatus capable of producing a plate polymer having extremely high plate thickness precision irrespective of the width of a belt of the apparatus, and a method of producing such a plate polymer.

Further, an object of the present invention is to provide a belt type continuous plate manufacturing apparatus capable of producing a plate polymer free from scars and bright spots and excellent for use in optical applications, and a method of producing such a plate polymer.

The present inventors have repeatedly conducted experiments for achieving the above-mentioned objects, and resultantly found that if the outer diameter of a roll body portion of an upper and lower roll pair is set in a specific range, the rigidity of the roll body portion becomes sufficiently high, a spacing of the roll pair in the belt running direction can be kept to be an appropriate distance such that the amount of belt deflection decreases, and a plate product having extremely high plate thickness precision with a reduced centrally thickened shape is thus obtained.

Namely, the present invention is a belt type continuous plate manufacturing apparatus comprising two endless belts so placed that their facing belt surfaces run toward the same direction at the same speed, and continuous gaskets running under condition of being sandwiched by belt surfaces at their both side edge portions, wherein a polymerizable raw material is fed into a space surrounded by the facing belt surfaces and the continuous gaskets from its one end, the polymerizable raw material is solidified together with running of the belts in a heating zone, and the plate polymer is taken out from the other end, characterized in that a plurality of upper and lower roll pairs each composed of an upper roll in contact with the upper surface of the upper belt and a lower roll in contact with the lower surface of the lower belt and having axes orthogonally crossing the belt running direction are placed along the belt running direction as a belt surface holding mechanism for the endless belts facing each other and running in the heating zone, and the outer diameter D of the roll body portion of the upper and lower roll pair is in the range of 100 mm to 500 mm.

It is preferable that the surfaces of the two endless belts in contact with the polymerizable raw material are mirror-polished so that the value of surface roughness Ra specified by the roughness and shape parameter of JIS (JIS B 0601-1994) is 0.1 μm or less, and the maximum diameter of pinholes is preferably 250 μm or less.

Furthermore, the present invention is a method of producing a plate polymer characterized in that a plate polymer is obtained from a polymerizable raw material containing methyl methacrylate, using the above-mentioned belt type continuous plate manufacturing apparatus.

While further conducting studies, the present inventors have found that the upper roll of the upper and lower roll pair of the belt type continuous plate manufacturing apparatus has a relatively small amount of deflection because its self weight and a repulsive force from an inner liquid pressure of a raw material are in opposite directions, and the lower roll has an extremely larger amount of deflection than the upper roll because its self weight and the repulsive force from the inner liquid pressure of the raw material are in the same downward direction. Namely, it has been found that correction of a deflected shape of the lower roll is the best approach for effectively eliminating a centrally thickened shape of a product and obtaining a plate which is not warped and has extremely smooth surfaces on both sides.

Based on such a point of view, the present inventors have explored a method of eliminating a centrally thickened shape of a plate product, and resultantly found an epoch-making method in which for example, the lower roll body portion is previously made to have a crown shape or the like with the width direction central portion having a diameter larger than that of the end portion, and a linear load from the upper roll body portion to the belt surface is adjusted, whereby a shape transferred to the belt surface by the lower roll body portion can easily be controlled, and the centrally thickened shape can essentially be eliminated without increasing the roll body diameter and the roll pair spacing.

Namely, the present invention is a method of producing a plate polymer, characterized in that using the above-mentioned belt type continuous plate manufacturing apparatus in which a lower roll axis of the upper and lower roll pair is supported on a fixed side wall, an upper roll axis of the upper and lower roll pair is supported on a beam capable of moving up and down, and a spring is placed in contact with said beam, the amount of width direction deflection of upper and lower rolls is adjusted by adjusting a linear load applied to the belt surface by the upper roll by changing the compression length or extension length of said spring, and a plate polymer is obtained from a polymerizable raw material containing methyl methacrylate.

### BRIEF DESCRIPTION OF THE DRAWINGS

FIG. 1 is a schematic sectional view showing one example of a belt type continuous plate manufacturing apparatus of the present invention;

FIG. 2 is a schematic diagram showing one example of a crown roll which is used for a lower roll 4′ of FIG. 1;

FIGS. 3(a) and 3(b) are schematic sectional views illustrating a roll pair having a linear load adjusting mechanism using a flat roll for an upper roll and a crown roll for a lower roll, both figures respectively representing two states in which the compression length of a spring is changed;

FIGS. 4(a) and 4(b) are schematic sectional views illustrating a roll pair having a linear load adjusting mechanism using a flat roll for the upper roll and a crown roll for the lower roll, both figures respectively representing two states in which the extension length of a tension spring is changed;

FIG. 5 is a perspective view showing plate sizes in evaluation in examples and comparative examples; and

FIG. 6 is a perspective view showing plate sizes in evaluation in examples and comparative examples.

### BEST MODE FOR CARRYING OUT THE INVENTION

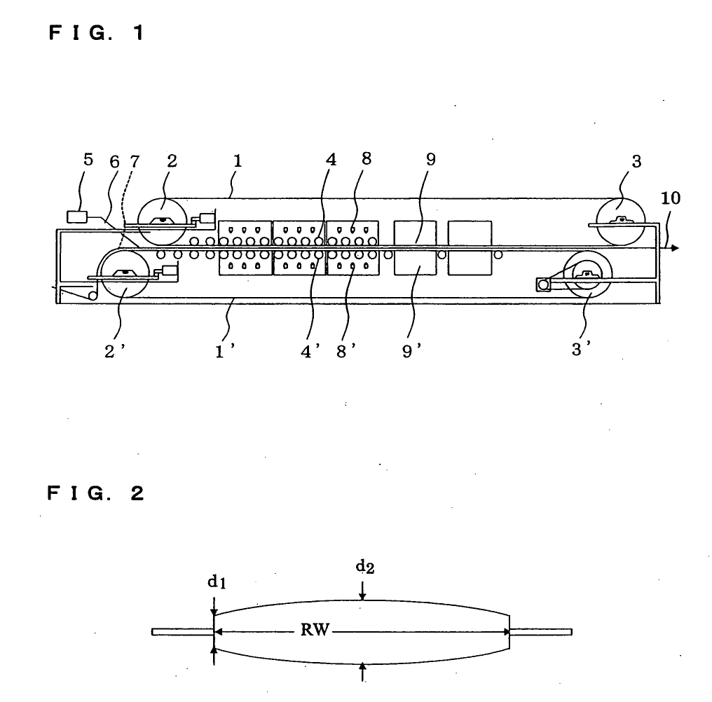

FIG. 1 is a schematic sectional view showing one example of the belt type continuous plate manufacturing apparatus of the present invention.

In the apparatus shown in this drawing, two endless belts (e.g., stainless steel belts) 1, 1′ are given tension by main pulleys 2, 3, 2′, 3′, and the lower belt 1′ is driven by the main pulley 3′ and runs. A liquid polymerizable raw material containing a polymerizable compound is fed by a metering pump 5, and fed from a nozzle 6 onto the surface of a lower belt. The endless belts 1, 1′ have a width of preferably from 500 mm to 5000 mm, and a thickness of preferably from 0.1 mm to 3 mm. The tension applied to the endless belts 1, 1′ is preferably in the range of 1 kg to 15 kg per cross-sectional area (1 mm²) vertical to the running direction. The endless belt 1 runs to the same direction at the same speed as that of the endless belt 1′ by frictional force via a gasket and plate polymer described later. The running speed is preferably from 0.1 m/min to 10 m/min, and can be appropriately changed depending on circumstances such as the thickness of a plate produced, timing of switching of articles, and the like.

Both side edge portions between belt surfaces are sealed with an elastic gasket 7. The polymerizable raw material is solidified in a heating zone as endless belts 1, 1′ run. As a heating zone, there is a zone heated by, for example, hot water sprays 8, 8′. Polymerization proceeds in the heating zone, and a temperature peak by heat of polymerization is attained at a certain position. Thereafter, polymerization is completed by a heat treatment with, for example, far infrared heaters 9, 9′, and a plate product (plate polymer) 10 is taken out. It is preferable that the district of the hot water sprays 8, 8′ have a temperature range of 50 to 100° C., and the district of the far infrared heaters 9, 9′ have a temperature range of 100° C. to 150° C. Other heating systems such as hot air may be used for both districts. The upper and lower roll pair covers rolls existing in the heating zone, but does not cover rolls existing in the heat treatment district.

As a belt surface holding mechanism for the endless belts 1, 1′ in the heating zone, upper and lower roll pairs 4, 4′ each composed of an upper roll in contact with the upper surface of the upper belt and a lower roll in contact with the lower surface of the lower belt having axes orthogonally crossing the belt running direction are used. By setting the outer diameter D of the roll body portion of the upper and lower roll pairs 4, 4′ to 100 mm to 500 mm, the effect of the present invention is obtained. If this outer diameter D is less than 100 mm, the amount of deflection of the roll body portion has a value large enough to exceed to the thickness of a plate product in some cases, leading to the hazardous situation in which width direction end portions of upper and lower endless belts are in contact with each other. If the outer diameter D exceeds 500 mm, it is necessary to increase a roll arrangement distance P in the belt running direction, it is also necessary to design a belt polymerization apparatus to have extremely high rigidity as a whole as the self-weight of the roll increases, and this is undesirable in terms of equipment costs. Further, in the case of a large plate manufacturing apparatus having a belt width of 1800 mm or greater, the outer diameter D of the roll body portion is preferably in the range of 130 to 500 mm. For the dimensional accuracy of the roll body portion in the flat roll, the tolerance of the outermost diameter is preferably 0.1 mm or less.

A difference [P−D] between the arrangement distance P of the upper and lower roll pairs 4, 4′ in the belt running direction and the outer diameter D of the roll body portion should be reduced wherever possible for plate thickness precision. In the heating zone, however, if the difference [P−D] is less than 50 mm, it is undesirable because it is impossible to secure the area of contact between a heating medium such as the hot water spray or hot air and the belt surface in some case, and resultantly the polymerization reaction is delayed to significantly reduce productivity. If the difference [P−D] exceeds 500 mm, deflection of the endless belt between roll pairs is promoted, and it is undesirable. Therefore, it is preferable that the apparatus is designed so that the difference [P−D] between the roll arrangement distance P in the belt running direction and the outer diameter D of the roll body portion is in the range of 50 mm to 500 mm. All the roll pairs 4, 4′ may be placed at a constant interval in the belt running direction, or the distance may be partially changed.

The polymerizable raw material is heated and progressively polymerized/solidified as the endless belts 1, 1′ run, and a temperature peak by heat polymerization is attained at a certain position. The heating zone including the position showing the temperature peak by heat polymerization usually has a plurality of upper and lower roll pairs 4, 4′ placed therein. In this district, so called a crown roll with the roll body portion having a crown shape is preferably used for at least some of a plurality of lower rolls 4′. By introduction of the crown roll, the centrally thickened shape of the plate product originating from deflection of the roll body portion can be substantially eliminated.

Regarding the number of crown rolls introduced, when the total number of upper and lower roll pairs 4, 4′ placed in the above-mentioned district is set to 100%, the number of upper and lower roll pairs 4, 4′ having a crown roll as the lower roll 4′ is preferably 4% or greater of the total number, more preferably 8% or greater, especially preferably 10% or greater. A plurality of crown rolls may be placed continuously in the belt running direction, or may be placed alternately or intermittently at an interval of several rolls in combination with flat rolls in which the tolerance of the outermost diameter of the roll body portion is 0.1 mm or less (hereinafter, abbreviated as “flat roll” in some cases).

In production of a plate product using the belt type continuous plate manufacturing apparatus of the present invention, when the total number of upper and lower roll pairs placed at a position nearer to the raw material feeding side than the position showing the peak by heat polymerization in the heating zone in the process in which the polymerizable raw material is solidified while running with the belt is set to 100%, the number of the upper and lower roll pairs with the lower roll body portion having a crown shape is preferably 4% or greater, more preferably 8% or greater, especially preferably 10% or greater.

If the running speed of the endless belt is changed depending on production conditions, and the position of the peak by heat polymerization varies, the effect can be exhibited for all production conditions by introducing a crown roll as the lower roll 4′ of the upper and lower roll pair at a position nearer to the raw material feeding side than the peak by heat polymerization under a production condition such that the position of the peak by heat polymerization is nearest to the raw material feeding side.

When the district between the inlet and the outlet of the heating zone is set to 0 to 100%, it is effective that the position of introduction of the crown roll is in a district of 0% to 90%, and it is more effective and preferable that crown rolls are intensively placed in a district of 30% to 90%.

In production of a plate polymer using the belt type continuous plate manufacturing apparatus of the present invention, if the position of introduction of the crown roll is at a position more upstream than the peak by heat polymerization, solidification of a raw material by the polymerization reaction is not completed yet, and therefore the shape of the roll body portion is effectively transferred to the shape of the raw material. When the district between the inlet of the heating zone and the position showing the peak by heat polymerization in the process in which the polymerizable raw material is solidified while running with the belt is set to 0% to 100%, upper and lower roll pairs with the lower roll body portion having a crown shape are placed preferably in a district of 0% to 90%, more preferably in a district of 30% to 90%.

FIG. 2 is a schematic sectional view showing one example of the crown roll. In this crown shape, a crown amount x represented by half a difference in diameter between the outermost diameter d₁ of the end portion of the roll body portion and the outermost diameter d₂ of the central portion shown by the following formula (1) and a self-weight deflection amount y of the roll body portion calculated from the following formula (2) preferably satisfies the following formula (3).
x=(d₂−d₁)/2 (1)
y=5S×ρ×RW⁴/(384×E×I) (2)
x≧y (3)
S: area of cross section vertical to axis direction of roll body portion
ρ: density of material of roll body portion
RW: width of roll body portion
E: Young's modulus of material of roll body portion
I: secondary moment of cross section vertical to axis direction of roll body portion

The crown shape may be either a radial type or taper type. The outer diameter D of the roll body portion in the present invention is the outermost diameter d2 of the central portion in the case of the crown roll.

In the present invention, the distance along the belt running direction is represented by “length”, and the distance along the direction orthogonally crossing the belt running direction, namely along the roll axis direction is represented by “width”.

Regarding the material of the body portion of the roll that is used for the upper and lower roll pairs 4,4′, for example, roll body portions composed of various metals such as stainless steel, iron and aluminum may be used, or roll body portions composed of carbon composite materials such as carbon rolls may be used. A rubber may be coated on the surface of the roll body portion for the purpose of alleviating damage to the surface of a stainless steel belt. The roll body portion may have a structure in which the outermost diameter after coating of the rubber has a crown shape. However, if the thickness of the rubber is too large, the diameter of the roll body becomes so large that the contact between the heating medium and the belt surface is inhibited, and the amount of self-weight deflection of the roll body portion is increased. In consideration of these respects, the thickness of the coated rubber is preferably in the range of 3 mm to 20 mm.

For the upper roll 4 of the upper and lower roll pair 4, 4′, either a flat roll or crown roll may be used. However, if the crown roll is used, it is desirable that the upper roll 4 have a crown amount x smaller than that of the lower crown roll 4′.

A mechanism capable of changing a linear load on the belt surface from the upper roll axis portion of the upper and lower roll pair 4, 4′, and a method of controlling plate thickness precision by load adjustment using this mechanism will now be described in detail.

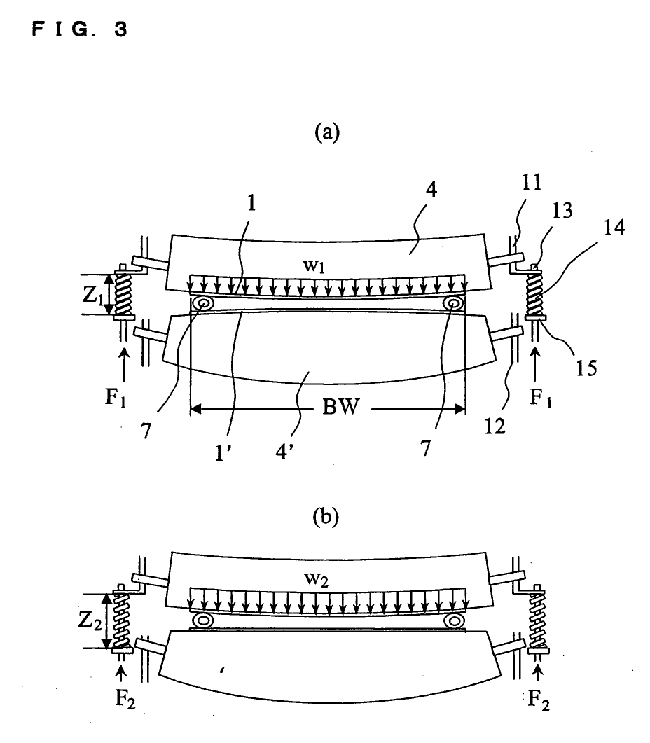

FIGS. 3(a) and (b) are schematic sectional views illustrating a roll pair having a linear load adjusting mechanism using a flat roll for the upper roll 4 and a crown roll for the lower roll 4′. Both axis portions of the lower roll 4′ are supported via a bearing on a side wall immovably fixed with a base. Both axis portions of the upper roll 4 are supported via a bearing on a frame 11 capable of being smoothly moved up and down by up-and-down movement of a support bar 13.

As shown in FIG. 3(a), a spring 14 having a natural length Z₀ is compressed between the frame 11 and a seat 15 so that its length has a value Z₁ (compression length) smaller than Z₀, on both sides of the frame 11. At this time, provided that the spring constant k of the spring 14 is k, a force F₁ of lifting the frame 11 by the spring 14 can be represented by the following formula (4).
F₁=k(Z₀−Z₁) (4)

Here, provided that the total weight of the upper roll 4 and the frame 11 is Wᵣ, and the width of the belt is BW, a load w₁ per belt unit width transmitted from the upper roll 4 to the upper belt surface 1 can be represented by the following formula (5).
w₁=(Wᵣ−2F₁)/BW (5)

According to the formula (4), the load w₁ acts downward on the lower crown roll 4′ via the belt surface and the raw material, and the roll body portion is deflected by the load w₁ and the self-weight of the roll. However, by previously giving an appropriate crown shape to the lower crown roll 4′, the upper side of the roll body portion is raised upward, and the cross section of the inner liquid of the raw material has a slight centrally thinned shape along the width direction.

Then, as shown in FIG. 3(b), when the seat 15 is moved downward and fixed, the spring length has a value Z₂ (compression length) lager than Z₁, and the force F₁ changes into a force F₂ represented by the following formula (6).
F₂=k(Z₀−Z₂) (6)

Since F₁ is larger than F₂ as apparent from formulae (4) and (6), the load w₁ changes into a greater load w₂ according to the formula (5), the deflection of the lower roll 4′ is promoted, and the width direction shape of a raw material portion surrounded by the belts 1, 1′ and the gasket 7 becomes flatter for both upper and lower surfaces. Namely, by adjusting a linear load from the upper side, a width direction shape having extremely high flatness can be obtained.

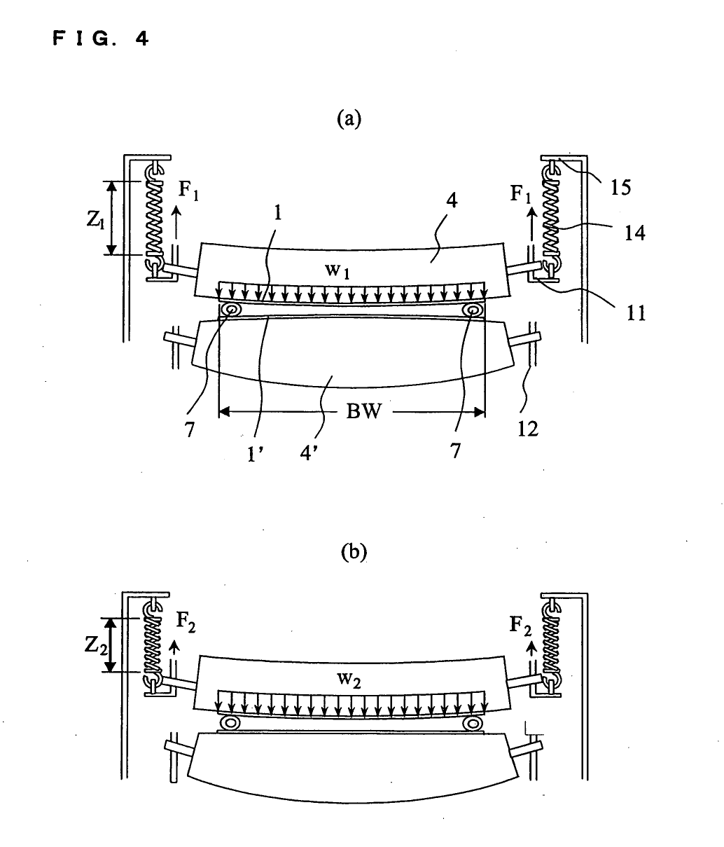

Even if the spring incorporated into the load adjusting mechanism is a tension type, the linear load can be adjusted just in the same manner as the case where a compression type spring is used, by changing the extension length from an extension length Z₁ to a smaller extension length Z₂ (Z₁>Z₂) by adjusting a beam 15 capable of moving up and down, to which the spring is connected, as shown in FIG. 4.

If loads w₁, w₂ per unit width transmitted from the upper roll 4 to the belt surface are too small, it is undesirable because adhesion between the gasket 7 and the upper stainless steel belts 1, 1′ decreases to raise the risk of leakage of the inner liquid of the raw material to outside. Conversely, if the load is too great, it is undesirable because it is necessary to extremely strengthen the structure of an axis portion of the lower roll 4′, and deformation of the side wall 12 is no longer negligible to degrade plate thickness precision. A preferable range of the load per unit width transmitted from the upper roll 4 to the belt surface is 10 kg/m to 200 kg/m.

The mechanism of adjusting a load from the upper side, of the present invention, is not limited to a system adjusting a force supporting from below a frame supporting the axis portion of the upper roll by the spring 14 shown in FIG. 3. For example, it may be a system applying a force directly to a link portion with the axis portion of the upper roll. The direction of applying a force is not limited to the upward force shown in FIG. 3, but the force may be applied downward to increase the load. One portion to which a force is applied may be provided for each roll pair, or a plurality of roll pairs may be linked by a frame, and then a site for applying a force to the frame via a spring may be provided.

The materials of the endless belts 1, 1′ are not specifically limited as long as they have sufficient corrosion resistance to a polymerizable raw material. For example, stainless steel such as austenite steel, martensite steel and austenite steel-martensite two phase steel is preferable because they have high corrosion resistance to various kinds of organic compounds. Above all, austenite steel is especially preferable.

Of surfaces of the upper and lower endless belts 1, 1′, their respective surfaces in contact with a polymerizable raw material are preferably mirror-polished in advance so that the value of surface roughness Ra specified by the roughness and shape parameter of JIS (JIS B0601-1994) is 0.1 μm or less. Further, the value of surface roughness Ra is more preferably in the range of 0.001 μm to 0.08 μm. The surface roughness Ra is a value determined by measuring five points per round for each of the upper and lower endless belts 1, 1′ using a previously known surface roughness measuring machine, and averaging the measurement values.

Mirror polishing can be carried out using a previously known polishing machine. The polishing machine is preferably a rotation type polishing machine using grinding stone or abrasive grain. Preferably, polishing is carried out by, for example, roughly smoothing the surface by primary polishing using rough grinding stone or abrasive grain, and then finishing the surface by secondary polishing using grinding stone or abrasive grain having a smaller grain size. The grain size of grinding stone or abrasive grain that is used in primary polishing is preferably 30 to 200 μm, and the grain size of grinding stone or abrasive grain that is used in secondary polishing is preferably 2 to 30 μm. For removing polishing wastes produced during polishing, a fluid filtered through a filter having an aperture of 200 μm or less is preferably fed to the polished surface. The fluid is preferably water.

After the polishing work described above, extremely high surface smoothness such that the value of surface roughness Ra is 0.1 μm or less can be obtained. However, even after such polishing work, pinholes having a diameter greater than 250 μm exist at a rate of 0.1 to 1 per square meter of the belt surface in many cases. Therefore, for obtaining the effect of the present invention, it is preferable that for example, the entire polished surface is inspected after polishing work, and if a pinhole having a diameter greater than 250 μm is found, an area around the pinhole is repolished.

For the method of detecting a pinhole having a diameter greater than 250 μm, visual inspection is sufficient. If a pinhole having a diameter greater than 250 μm is found, the pinhole can be exclusively eliminated while retaining a good mirror surface state of the belt surface by, for example, carrying out repolishing in such a manner that a circle having a radius of 20 mm to 200 mm is drawn with the pinhole at the center. This repolishing is carried out preferably at two stages of primary polishing and secondary polishing. After such repolishing work, a mirror surface in which the maximum diameter of pinholes is 250 μm or less can be obtained. Further, the maximum diameter of pinholes is more preferably 200 μm or less.

Foreign substance deposited on the back surface of the endless belt of the belt type continuous plate manufacturing apparatus for some reason during operation may be caught between main pulleys at both ends of the apparatus and the endless belt to cause the endless belt to be deformed. Thus, for preventing such deformation, an apparatus for preventing foreign substance from entering between the endless belt and the main pulleys is preferably provided on the back face of the endless belt just before the main pulleys at both ends. As a system of the foreign substance entrance preventing apparatus, there are a method in which a resin plate of a material, such as polycarbonate, which is hard to be broken and has high heat resistance so as not to be deformed at its ambient temperature, is made to contact the back surface of the endless belt across its entire width to provide interception, a method in which a brush is made to contact the back surface of the endless belt across its entire width to provide interception, a method in which a bar having a length larger than the width of the endless belt, around which a soft cloth such as flannel is wound, is made to contact the back surface of the endless belt to provide interception, and the like. Particularly, the method using a resin plate and the method using a blush are preferable, and a method using these methods in combination is more preferable. A method in which the brush type foreign substance entrance preventing apparatus is placed on the downstream side of the resin plate type foreign substance entrance preventing apparatus is most preferable because even in the event that the resin plate is broken, the broken resin plate is intercepted by the brush type foreign substance entrance preventing apparatus, and the broken resin plate does not enter a gap between the main pulley and the endless belt.

The thickness of a plate polymer produced according to the present invention is preferably about 0.3 to 20 mm.

A raw material of a plate polymer can be appropriately selected depending on the intended plate polymer. The continuous plate manufacturing apparatus of the present invention is suitable particularly for production of a methacrylic resin plate using methyl methacrylate as the main raw material. In producing a methacrylic resin plate, it is preferable to a polymerizable raw material containing methyl methacrylate in an amount of 50 wt % or more. Typically, single methyl methacrylate, or mixtures with other monomers copolymerizable with methyl methacrylate are listed. Further, a syrup obtained by dissolving a methyl methacrylate-based polymer in methyl methacrylate or a mixture thereof, and a syrup obtained by previously polymerizing a part of methyl methacrylate or a mixture thereof are also listed.

As the other copolymerizable monomers, listed are, for example, acrylates such as methyl acrylate, ethyl acrylate, n-butyl acrylate and 2-ethylhexyl acrylate; methacrylates other than methyl methacrylate such as ethyl methacrylate, n-butyl methacrylate and 2-ethylhexyl methacrylate; vinyl acetate, acrylonitrile, methacrylonitrile and styrene. In the case of a syrup, the polymer content is preferably regulated to 50 wt % or less in view of flowability of a polymerizable raw material.

To the polymerizable raw material, a chain transfer agent can also be added, if necessary. As the chain transfer agent, for example, primary, secondary or tertiary mercaptans having an alkyl group or substituted alkyl group can be used. Specific examples thereof include n-butylmercaptan, i-butylmercaptan, n-octylmercaptan, n-dodecylmercaptan, s-butylmercaptan, s-dodecylmercaptan and t-butylmercaptan.

To the polymerizable raw material, a polymerization initiator is usually added. Specific examples thereof include organic peroxides such as tert-hexyl peroxypivalate, tert-hexyl peroxy-2-ethylhexanoate, di-isopropyl peroxydicarbonate, tert-butyl neodecanoate, tert-butyl peroxypivalate, lauroyl peroxide, benzoyl peroxide, tert-butyl peroxyisopropylcarbonate, tert-butyl peroxybenzoate, dicumyl peroxide and di-tert-butyl peroxide; azo compounds such as 2,2′-azobis(2,4-di-methylvaleronitrile), 2,2′-azobisisobutyronitrile, 1,1′-azobis(1-cyclohexanecarbonitrile) and 2,2′-azobis(2,4,4-trimethylpentane).

In addition, various additives, for example, cross-linking agents, ultraviolet absorbers, light stabilizers, oxidation stabilizers, plasticizers, dyes, pigments, releasing agents, acrylic multi-layer rubbers can also be added to a raw material, if necessary.

The following examples will illustrate the present invention further in detail below, but do not limit the scope of the invention. In the following description, “part” is based on mass.

### EXAMPLE 1

To 100 parts of a methyl methacrylate syrup (viscosity: 1 Pa·s, 20° C.) having a degree of polymerization of 20% by mass was added 0.1 part of tert-hexyl peroxypivalate (manufactured by NOF Corp., trade name: Perhexyl PV) as a polymerization initiator and 0.005 parts of sodium dioctylsulfosuccinate as a releasing agent and they were uniformly mixed, to obtain a liquid polymerizable raw material. This polymerizable raw material was de-foamed in a vacuum vessel, and applied to the apparatus in FIG. 1 to produce a plate product 1 having a thickness of 5 mm and a width of 1800 mm.

In this example, the apparatus in FIG. 1 has a total length of 10 m, two stainless steel endless belts 1, 1′ have a thickness of 1.5 mm and a width of 2 m, and both of them are given a tension of 3 kg/mm² by hydraulic pressure. As the gasket 7, a gasket made of a polyvinyl chloride is mounted.

The front half part of the apparatus has a heating zone of 5 m by 76° C. hot water sprays 8, 8′. In this heating zone, upper and lower roll pairs 4, 4′ are placed at a uniform interval in a total number of 12 such that the arrangement distance P of roll pairs is 400 mm. Each roll of these upper and lower roll pairs 4, 4′ is composed of a hollow body portion made of stainless steel with its surface covered with a rubber, and solid axis made of stainless steel at its both side portions. The outer diameter of the stainless steel body portion of each roll of the upper and lower roll pairs 4, 4′ is 160 mm, the outermost diameter including the rubber part is 180 mm, the width is 2200 mm, the stainless steel thickness is 4.5 mm, the tolerance of the outermost diameter is 0.1 mm or less, namely, the roll is a flat roll, the outer diameter of the solid axis is 20 mm, and the width of the solid axis is 125 mm.

The self-weight deflection of this flat roll is 0.06 mm from the formula (2). Here, a difference [P−D] between the arrangement distance P of the upper and lower roll pairs 4, 4′ in the heating zone and the outer diameter D of the body portion is 400 mm−180 mm=220 mm.

In the upper and lower roll pairs 4, 4′, the axis of the upper roll 4 is supported via a bearing on a frame capable of moving up and down with up-and-down movement of a support bar. The axis of the lower roll 4′ is supported via a bearing on a side wall 12 fixed on a base.

Further, in sixth and seventh upper and lower roll pairs 4, 4′ from the raw material feeding side in the heating zone, as shown in FIG. 3, a spring 14 is mounted between a frame 11 supporting the axis of the upper roll 4 and a seat 15 of a support bar 13 so that a linear load from above can be adjusted, and the spring 14 is adjusted so that the load from above is 20 kg/m per unit width of the belt for both the sixth and seventh upper and lower roll pairs 4, 4′ from the raw material feeding side in the heating zone during operation.

After the heating zone by the hot water sprays 8, 8′, a district of 2 m for thermal treatment by far infrared heaters 9, 9′ is present.

The endless belts 1, 1′ were operated at a running speed of 130 mm/min. For knowing a peak by heat polymerization, a thermocouple was introduced from the raw material feeding side together with the raw material, the temperature of a raw material liquid near the thermocouple was measured with the passage of time, and its position was matched with the position of the polymerization apparatus. As a result, the peak by heat polymerization was located at a position of 4.2 m from the raw material feeding side of the heating zone by the hot water sprays 8, 8′.

### EXAMPLE 2

A plate product 2 was obtained in the same manner as in Example 1 except that a crown roll was used instead of a flat roll as the lower rolls 4′ of second and third upper and lower roll pairs 4, 4′ from the raw material feeding side in the heating zone of the apparatus of FIG. 1, namely the crown roll was used for a district of 12% to 28% of the hot water zone when seen from the raw material feeding side, i.e. 17% of the total number of lower rolls. This crown roll is identical in structure and size to the flat roll used in Example 1 except that the outer diameter d₂ including the rubber at the center is 180.0 mm (the outer diameter of the stainless steel body portion is 160.0 mm) and the outermost diameter d₁ including the rubber at the end portion is 179.8 mm (the outer diameter of the stainless steel body portion is 160.0 mm). The self-weight of this crown roll is 0.06 mm from the formula (2).

### EXAMPLE 3

A plate product 3 was obtained in the same manner as in Example 1 except that a crown roll was used instead of a flat roll as the lower rolls 4′ of sixth and seventh upper and lower roll pairs 4, 4′ (with a linear load adjusting mechanism) from the raw material feeding side in the heating zone of the apparatus of FIG. 1, namely the crown roll was used for a district of 44% to 60% of the hot water zone when seen from the raw material feeding side, i.e. 17% of the total number of lower rolls. This crown roll is identical in structure and size to the flat roll used in Example 2.

### EXAMPLE 4

After the polymerizable raw material 1 was de-foamed in a vacuum vessel, a plate product 4 having a thickness of 3 mm and a width of 2800 mm was produced by an apparatus of FIG. 1 which was larger than the apparatus used in Example 1.

In this example, the apparatus in FIG. 1 has a total length of 100 m, two stainless steel endless belts 1, 1′ have a thickness of 1.5 mm and a width of 3000 mm, and both of them are given a tension of 8 kg/mm² by hydraulic pressure. As the gasket 7, a gasket made of a polyvinyl chloride is mounted.

The front half part of the apparatus has a heating zone of 48 m by 80° C. hot water sprays 8, 8′. In this heating zone, upper and lower roll pairs 4, 4′ are placed at a uniform interval in a total number of 120 such that the arrangement distance P of roll pairs is 400 mm. Each roll of these upper and lower roll pairs 4, 4′ is composed of a hollow body portion made of iron with its surface covered with a rubber, and solid axis made of stainless steel at its both side portions. The outer diameter of the iron body portion of each roll of the upper and lower roll pairs 4, 4′ is 264 mm, the outermost diameter including the rubber part is 280 mm, the width is 3200 mm, the iron thickness is 7.6 mm, the tolerance of the outermost diameter is 0.1 mm or less, namely, the roll is a flat roll, the outer diameter of the solid axis is 80 mm, and the width of the solid axis is 400 mm.

The self-weight deflection of this flat roll is 0.08 mm from the formula (2). Here, a difference [P−D] between the arrangement distance P of the upper and lower roll pairs 4, 4′ and the outer diameter D of the body portion is 400 mm−280 mm=120 mm.

In the upper and lower roll pairs 4, 4′, the axis of the upper roll 4 is supported via a bearing on a frame capable of moving up and down with up-and-down movement of a support bar. The axis of the lower roll 4′ is supported via a bearing on a side wall 12 fixed on a base.

Further, in all the upper and lower roll pairs 4, 4′ in the above-mentioned heating zone, as shown in FIG. 3, a spring 14 is mounted between a frame 11 supporting the axis of the upper roll 4 and a seat 15 of a support bar 13 so that a linear load from above can be adjusted, and the spring 14 is adjusted so that the load from above for the upper and lower roll pairs in a district of 20 to 28 m from the raw material feeding side in the heating zone is 30 kg/m per unit width of the belt.

After the heating zone by the hot water sprays 8, 8′, a district of 15 m for thermal treatment by far infrared heaters 9, 9′ is present.

In the heating zone by the hot water sprays 8, 8′, the temperature of the width direction end portion of the lower endless belt 1′ was measured in total 12 points at an interval of 4 m by a thermocouple, and a district having the highest temperature was determined to be a position of the peak by heat polymerization. When the endless belts 1,1′ were operated at a running speed of 2.3 m/min, the peak by heat polymerization was located in a district of 40 to 44 m.

### EXAMPLE 5

A plate product 5 was obtained in the same manner as in Example 4 except that the crown roll was used instead of the flat roll as total 20 lower rolls 4′ in the district of 20 to 28 m of the heating zone by the hot water sprays 8, 8′ of the apparatus of FIG. 1, namely the crown roll was used for a district of 42% to 58% of the hot water zone when viewed from the raw material feeding side, i.e. 17% of the total number of lower rolls. This crown roll is identical in structure and size to the flat roll used in Example 4 except that the outer diameter d₂ including the rubber at the center is 280.0 mm (the outer diameter of the iron body portion is 264 mm), the outermost diameter d₁ including the rubber at the end portion is 279.6 mm (the outer diameter of the iron body portion is 264 mm), and the iron thickness is 7.6 mm. The self-weight of this crown roll is 0.08 mm from the formula (2).

Furthermore, a plate product 6, a plate product 7 and a plate product 8 were obtained in the same manner as in the case where the plate product 5 was obtained except that for the upper and lower roll pairs 4, 4′ at 20 to 28 m from the raw material feeding side in the heating zone, set values for the spring 14 mounted on the frame 11 were changed so that loads on the belt surface were 80 kg/m, 130 kg/m and 180 kg/m, respectively.

### EXAMPLE 6

A plate product 9 was obtained in the same manner as in Example 4 except that the crown roll was used instead of the flat roll as total 70 lower rolls 4′ in the district of 0 to 28 m of the heating zone by the hot water sprays 8, 8′ of the apparatus of FIG. 1, namely the crown roll was used for a district of 0% to 58% of the hot water zone when viewed from the raw material feeding side, i.e. 58% of the total number of lower rolls. This crown roll was identical in structure and size to that used in Example 5.

Furthermore, plate products 10, 11 were obtained in the same manner as in the case where the plate product 9 was obtained except that running speeds of the endless belt were 1.8 m/min and 1.3 m/min, respectively. Positions of the peak by heat polymerization at this time were districts of 32 to 36 m and 20 to 24 m, respectively.

### COMPARATIVE EXAMPLE 1

A plate product 12 was obtained in the same manner as in Example 1 except that in total 12 upper and lower roll pairs 4, 4′ in the heating zone by the hot water sprays 8, 8′, the outer diameter of the stainless steel body portion was changed to 80 mm, and the outermost diameter including the rubber part was changed to 96 mm.

### EXAMPLE 7

A plate product 13 was obtained in the same manner as in Example 1 except that total 12 upper and lower roll pairs 4, 4′ in the heating zone by the hot water sprays 8, 8′ were changed to total 6 pairs by removing the pair on an alternate basis, and the difference [P−D] between the arrangement distance P of the upper and lower roll pairs 4, 4′ and the outer diameter D of the roll body portion was 800 mm−180 mm=620 mm.

### EXAMPLE 8

A plate product 14 was obtained in the same manner as in Example 4 except that of total 20 lower rolls 4′ in the district of 20 to 28 m from the raw material feeding side of the heating zone by the hot water sprays 8, 8′, 4 rolls from the raw material feeding side were changed to the crown roll used in Example 5, namely the crown roll was used for a district of 42% to 45% when viewed from the raw material feeding side, i.e. 3.3% of the total number of lower rolls.

### EVALUATION

The plate thickness precision of the products 1 to 3 and 13 (Examples 1 to 3 and 7) and the product 12 (Comparative Examples 1) were evaluated by the following method. First, as shown in FIG. 5, a plate product taken out continuously was cut every 1000 mm along the longitudinal direction, to obtain 50 plates of 1800 mm×1000 mm×5 mm. On all of these 50 plates, the thickness at the center point A in the width direction of the section and at points B₁, B₂ situated 100 mm inside from both ends were measured, an average value thereof was calculated, and central protrusive amount T represented by the following formula (7) was determined.
T=A−(B₁+B₂)/2 (7)

In evaluation of plate thickness precision, when the absolute value of this central protrusive amount is smaller, a flat property along the width direction is higher.

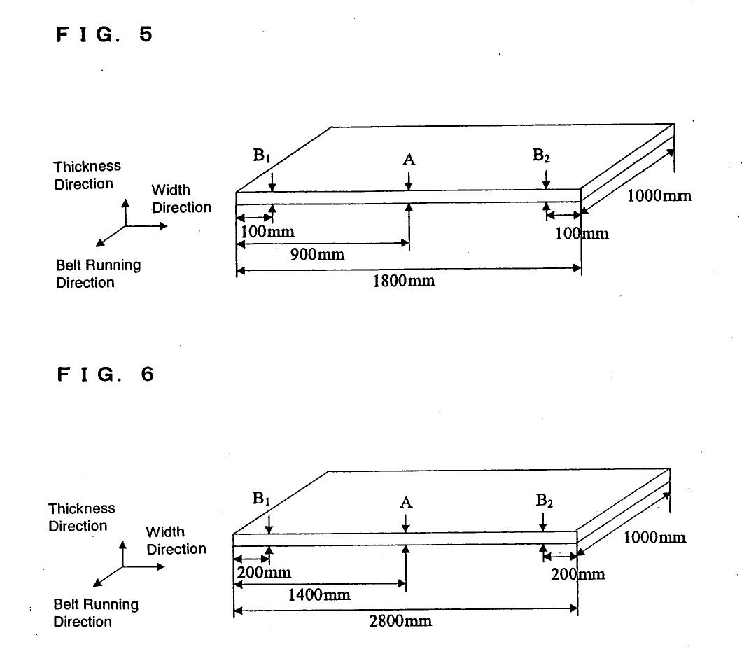

The plate thickness precision of the products 4 to 11 and 14 (Examples 4 to 6 and 8) was evaluated in the same manner as described above except that the size of 50 plates was 2800 mm×1000 mm×3 mm and the points B₁, B₂ were situated 200 mm inside from both ends, as shown in FIG. 6.

The evaluation results are shown in Table 1.

TABLE 1
Evaluation Results

| No. of plate | Central protrusive amount |
|---|---|
| product | [mm] (average of 50 plates) |
| 1 | 0.10 |
| 2 | 0.05 |
| 3 | 0.01 |
| 4 | 0.09 |
| 5 | −0.09 |
| 6 | −0.01 |
| 7 | 0.05 |
| 8 | 0.11 |
| 9 | −0.09 |
| 10 | −0.08 |
| 11 | −0.10 |
| 12 | 0.32 |
| 13 | 0.27 |
| 14 | 0.10 |

As apparent from the results shown Table 1, the plate product 1 (Example 1) had a flat sufficient for light transmission plate applications with its centrally thickened shape T having a small value. Further, the centrally thickened shape T of the plate product 2 (Example 2) had a smaller value, and the centrally thickened shape T of the plate product 3 (Example 3) had a further smaller value.

Similarly, the plate product 4 (Example 4) had a flat property sufficient for light transmission plate applications with its centrally thickened shape T having a small value. Each of the centrally thickened shapes T of the plate products 5, 6, 7 and 8 (Example 5) had a small value, and particularly the plate product 6 had an extremely high flat property.

Each of the centrally thickened shapes T of the plate products 9, 10 and 11 (Example 6) had a small value. From this fact, it can be understood that the high flat property of the plate product does not change even if the speed of continuous production during operation is changed.

The plate product 12 (Comparative Example 1) was a plate poor in plate thickness precision with its centrally thickened shape T having a high value. The plate product 13 (Example 7) was not excellent in plate thickness precision with its centrally thickened shape T having a higher value than that of the plate product 1 (Example 1), but was better than the plate of Comparative Example 1. The centrally thickened shape T of the plate product 14 (Example 8) was almost equivalent to that of the plate product 4 (Example 4), the number of crown rolls introduced for the lower roll in the heating zone was 4% or less of the total number, and therefore it could not be said that its effect was high.

### EXAMPLE 9

To 100 parts of a methyl methacrylate syrup (viscosity: 1 Pa·s, 20° C.) having a degree of polymerization of 20% by mass was added 0.35 parts of tert-hexyl peroxypivalate as a polymerization initiator and 0.005 parts of sodium dioctylsulfosuccinate as a releasing agent and they were uniformly mixed, to obtain a liquid polymerizable raw material. This polymerizable raw material was de-foamed in a vacuum vessel, and applied to an apparatus set in the same manner as in Example 3 to produce a plate product (plate polymer) having a thickness of 2 mm, a width of 1800 mm and a length of 1000 mm.

In this example, the entire surfaces of upper and lower endless belts 1, 1′ made of austenite stainless steel on the side in contact with a polymerizable raw material were polished five times as primary polishing using abrasive grain having a grain size of 40 μm, and further polished twice as secondary polishing using grinding stone having a grain size of 20 μm. The value of surface roughness Ra of the upper and lower endless belts 1, 1′ after this mirror polishing, specified by the JIS roughness shape parameter (JIS B0601-1994), was 0.01 μm. A visual inspection was made over the entire surface after polishing, and resultantly pinholes having a diameter greater than 250 μm were detected in numbers of 5 and 6, respectively, for 42 m² of the surface area of the belt. Thus, repolishing (the above-mentioned primary polishing and secondary polishing) was carried out in such a manner that a circle having a radius of 100 mm was drawn with the position of the pinhole at the center, whereby all the pinholes were eliminated. By the polishing work described above, upper and lower endless belts 1, 1′ in which Ra of the surface in contact with the polymerizable raw material was 0.1 μm or less and the maximum diameter of the pinhole was 250 μm or less were obtained. The measurement of surface roughness Ra was carried out by measuring the Ra at 5 points per round for each of the upper and lower endless belts 1, 1′ using a surface roughness measuring machine: SV-3000S4 manufactured by Mitutoyo Co., Ltd. and the average value thereof was determined to be a value of Ra. Thereafter, the upper and lower endless belts 1, 1′ were incorporated into the apparatus.

In this example, the apparatus was operated for 2 days with the hot water sprays 8, 8′ kept at 80° C. and with the upper and lower endless belts 1, 1′ running at a speed of 200 mm/min. In the operation for two days, the time over which the product could be obtained by continuous operation exclusive of startup and shutdown time periods was 37.5 hours, and thereby 450 plate products (plate polymer) were obtained. The plate thickness precision of the product measured in accordance with Example 3 was satisfactory with the central protrusive amount T being 0.02 mm for 450 products.

The 450 plate products were visually inspected for existence/nonexistence of scars and bright spots. Specifically, stripe shapes observed when applying light from a fluorescent lamp from one of the surfaces of the plate product having a width of 1800 mm×a length of 1000 mm and making a visual inspection from the other face were counted as scars, and white spots observed at that time were counted as bright spots. As a result, among 450 products, 1 to 5 small scars were found in 7 products, and 1 or 2 bright spots were found in 8 products, but those products were sufficiently usable as optical applications. No product had both scars and bright spots.

### EXAMPLE 10

Of the polishing work for the upper and lower endless belts in Example 9, primary polishing (five times) was carried out, but subsequent secondary polishing and repolishing were not carried out. The value of surface roughness Ra after polishing was 0.15 μm. A visual inspection was carried out over the entire surface after polishing, and resultantly pinholes having a diameter greater than 250 μm were detected in numbers of 6 and 6, respectively, for 42 m² of the surface area of the belt.

450 plate products each having a thickness of 2 mm, a width of 1800 mm and a length of 1000 mm were produced in the same manner as in Example 9 except for the upper and lower endless belts were incorporated directly in the apparatus, and a visual inspection was made for existence/nonexistence of scars and bright spots. As a result, among 450 products, 1 to 5 small scars were found in 39 products (about 9% of the total) and 1 or 2 bright spots were found in 198 product (44% of the total). Among them, 26 products had both the scar and bright spot. Namely, total 211 products had one or both of the scar and the bright spot, and 147 products thereof (about 33% of the total) were hardly suitable as a product for optical applications.

As described above, according to the present invention, a belt type continuous plate manufacturing apparatus capable of producing a plate polymer having extremely high plate thickness precision irrespective of the width of a belt of the apparatus, and a method of producing the plate polymer can be provided.

1. A belt type continuous plate manufacturing apparatus comprising two endless belts so placed that their facing belt surfaces run toward the same direction at the same speed, and continuous gaskets running under condition of being sandwiched by belt surfaces at their both side edge portions, wherein a polymerizable raw material is fed into a space surrounded by the facing belt surfaces and the continuous gaskets from its one end, the polymerizable raw material is solidified together with running of the belts in a heating zone, and the plate polymer is taken out from the other end, characterized in that
a plurality of upper and lower roll pairs each composed of an upper roll in contact with the upper surface of the upper belt and a lower roll in contact with the lower surface of the lower belt and having axes orthogonally crossing the belt running direction are placed along the belt running direction as a belt surface holding mechanism for the endless belts facing each other and running in the heating zone, and the outer diameter D of the roll body portion of the upper and lower roll pair is in the range of 100 mm to 500 mm.

2. The belt type continuous plate manufacturing apparatus according to claim 1, wherein the widths of the two endless belts are both 1800 mm or greater, and the outer diameter D of the roll body portion of the upper and lower body pair is in the range of 130 mm to 500 mm.

3. The belt type continuous plate manufacturing apparatus according to claim 1, wherein a difference [P−D] between an arrangement distance P of a plurality of upper and lower roll pairs in the belt running direction and the outer diameter D of the roll body portion is in the range of 50 mm to 500 mm.

4. The belt type continuous plate manufacturing apparatus according to claim 1, wherein when the total number of upper and lower roll pairs is set to 100%, the roll body portion of the lower roll of said upper and lower roll pairs in a number of 4% or greater has a crown shape.

5. The belt type continuous plate manufacturing apparatus according to claim 4, wherein when a district from an inlet to an outlet of the heating zone is set to 0% to 100%, upper and lower roll pairs with the lower roll portion having a crown shape are placed in a district of 0% to 90%.

6. The belt type continuous plate manufacturing apparatus according to claim 4, wherein when a district from an inlet to an outlet of the heating zone is set to 0% to 100%, upper and lower roll pairs with the lower roll portion having a crown shape are placed in a district of 30% to 90%.

7. The belt type continuous plate manufacturing apparatus according to claim 4, wherein in the crown shape of the roll body portion of the lower roll, a crown amount x represented by half a difference in diameter between the outermost diameter d₁ of the end portion of the roll body portion and the outermost diameter d₂ of the central portion shown by the following formula (1) and a self-weight deflection amount x of the roll body portion calculated from the following formula (2) satisfies the following formula (3):
x=(d₂−d₁)/2 (1)
y=5S×ρ×RW⁴/(384×E×I) (2)
x≧y (3)
S: area of cross section vertical to axis direction of roll body portion
ρ: density of material of roll body portion
RW: width of roll body portion
E: Young's modulus of material of roll body portion
I: secondary moment of cross section vertical to axis direction of roll body portion.

8. The belt type continuous plate manufacturing apparatus according to claim 1, wherein all the upper rolls of the upper and lower roll pairs are flat rolls in which the tolerance of the outermost diameter of the roll body portion is 0.1 mm or less.

9. The belt type continuous plate manufacturing apparatus according to claim 1, wherein the surfaces of the two endless belts in contact with a polymerizable raw material are mirror-polished so that the value of surface roughness Ra specified by the JIS roughness shape parameter (JIS B0601-1994) is 0.1 μm or less, and the maximum diameter of pinholes is 250 μm or less.

10. A method of producing a plate polymer, characterized in that a plate polymer is obtained from a polymerizable raw material containing methyl methacrylate using the belt type continuous plate manufacturing apparatus according to claim 1.

11. The method of producing a plate polymer according to claim 10, said method using a belt type continuous plate manufacturing apparatus in which when the total number of upper and lower roll pairs placed at a position nearer to the raw material feeding side than a position showing a peak by heat polymerization in a heating zone in the process in which the polymerizable raw material is solidified while running with the belt is set to 100%, the number of said upper and lower roll pairs with the lower roll body portion having a crown shape is 4% or greater.

12. The method of producing a plate polymer according to claim 11, said method using a belt type continuous plate manufacturing apparatus in which when a district from an inlet of a heating zone to a position showing a peak by heat polymerization in the process in which the polymerizable raw material is solidified while running with the belt is set to 0 to 100%, upper and lower roll pairs with the lower roll portion having a crown shape are placed in a district of 0% to 90%.

13. The method of producing a plate polymer according to claim 11, said method using a belt type continuous plate manufacturing apparatus in which when a district from an inlet of a heating zone to a position showing a peak by heat polymerization in the process in which the polymerizable raw material is solidified while running with the belt is set to 0 to 100%, upper and lower roll pairs with the lower roll portion having a crown shape are placed in a district of 30% to 90%.

14. A method of producing a plate polymer, characterized in that using the belt type continuous plate manufacturing apparatus according to claim 1 in which a lower roll axis of the upper and lower roll pair is supported on a fixed side wall, an upper roll axis of the upper and lower roll pair is supported on a beam capable of moving up and down, and a spring is placed in contact with said beam,
the amount of width direction deflection of upper and lower rolls is adjusted by adjusting a linear load applied to the belt surface by the upper roll by changing the compression length or extension length of said spring, and a plate polymer is obtained from a polymerizable raw material containing methyl methacrylate.

15. The method of producing a plate polymer according to claim 14, wherein the linear load applied to the belt surface by the upper roll is adjusted to be in the range of 10 kg/m to 200 kg/m per unit width of the belt.

16. A method of producing a plate polymer, characterized in that a plate polymer is obtained from a polymerizable raw material containing methyl methacrylate using the belt type continuous plate manufacturing apparatus according to claim 9.
